(19) United States
(12) Patent Application Publication
(10) Pub. No.: US 2025/0203186 A1
(43) Pub. Date: Jun. 19, 2025

(54) HEAD FRAME FOR CAMERAS

(71) Applicant: Matthew C. Lewis, Glendale, AZ (US)

(72) Inventor: Matthew C. Lewis, Glendale, AZ (US)

(21) Appl. No.: 18/944,094

(22) Filed: Nov. 12, 2024

Related U.S. Application Data
(60) Provisional application No. 63/610,654, filed on Dec. 15, 2023.

(51) Int. Cl. H04N 23/54; A44C 5/22

(52) U.S. Cl. CPC H04N 23/54; A44C 5/22

(57) ABSTRACT

A head frame for cameras that includes a forehead portion, a back head portion, a top head portion, and a chin portion all interconnected and adjustable to fit a user's head snugly. A camera mount is connected to the chin portion and is adapted to releasably hold a camera thereto, such that a user can use the camera in a hands-free mode.

### CROSS-REFERENCE TO RELATED APPLICATION

The present application is related to and claims priority from prior provisional application Ser. No. 63/610,654, filed Dec. 15, 2023 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71 (d).

### BACKGROUND OF THE INVENTION

### 1. Field of the Invention

This invention relates generally to camera frames, and more specifically to a camera frame adapted to be worn on the head of a user.

### 2. Description of the Related Art

Prior art helmets have attachments for cameras, however the helmets themselves require chin straps to attach to a person's head, which are difficult to connect and are uncomfortable. Furthermore, the prior art helmets are not adapted to attach a camera in a position such that they can be viewed by the wearer of the helmet, therefore, it is difficult for the wearer to view the camera screen and/or know exactly where the camera is pointing, which usually results in poor and/or undesirable recordings. Thus, a need exists for a head frame for cameras to avoid the above-mentioned problems.

### BRIEF SUMMARY OF THE INVENTION

In view of the foregoing disadvantages inherent in the known types of helmets, head frames, camera mounts, or the like in the prior art, the present invention provides a head frame for cameras. As such, the general purpose of the present invention, which will be described subsequently in greater detail, is to provide a head frame for cameras that includes a forehead portion, a back head portion, a top head portion, and a chin portion all interconnected and adjustable to fit a user's head snugly, and a camera mount connected to the chin portion and is adapted to releasably hold a camera thereto, such that a user can use the camera in a hands-free mode, with all the advantages of the prior art and none of the disadvantages.

There has thus been outlined, rather broadly, the more important features of the invention in order that the detailed description thereof that follows may be better understood and in order that the present contribution to the art may be better appreciated. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a head frame for cameras, constructed and operative according to the teachings of the present invention.

FIG. 1 is a perspective view illustrating the head frame for cameras according to the preferred embodiment of the present invention.

FIG. 2 is a perspective view illustrating the head frame for cameras with a camera mount attached according to the preferred embodiment of the present invention of FIG. 1.

FIG. 3 is a perspective view illustrating a camera mount attachable to the head frame for cameras according to the preferred embodiment of the present invention of FIG. 1.

FIG. 4 is a view of the separate pieces of the head frame for cameras according to the preferred embodiment of the present invention of FIG. 1.

FIG. 5 is a perspective view illustrating the head frame for cameras worn by a user according to the preferred embodiment of the present invention of FIG. 1.

The various embodiments of the present invention will hereinafter be described in conjunction with the appended drawings.

### DETAILED DESCRIPTION

As discussed above, embodiments of the present invention relate to a head frame for cameras. The head frame for cameras was designed so it could be worn on a person's head and provide a stable mechanism for an action camera such as GoPro, Insta360, DJI Osmo, and a phone for a hands free point of view camera holder. The frame is designed to be modular sized. The idea is to support 3 head sizes with one frame by utilizing a stepped locking mechanism. It is thin and ultralight. It can be made from plastic. The idea is to easily place the frame on a person's head, slide the chin piece to your chin without the need for clamping or other straps to hold the frame on the person's head.

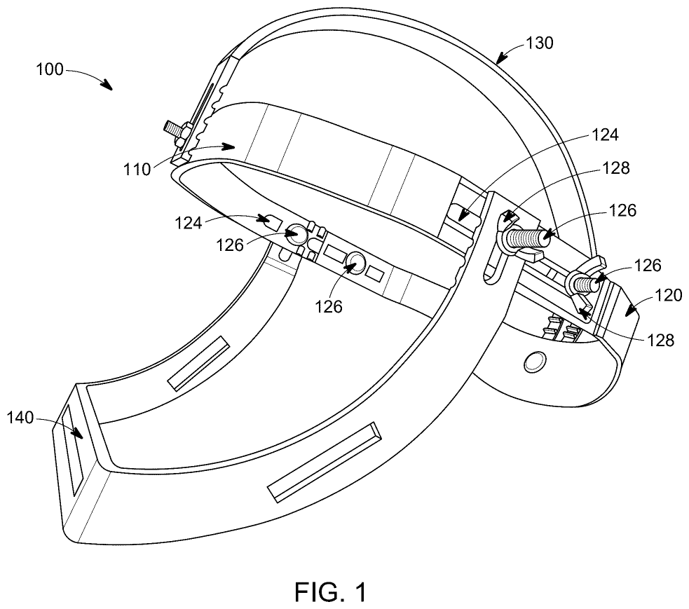

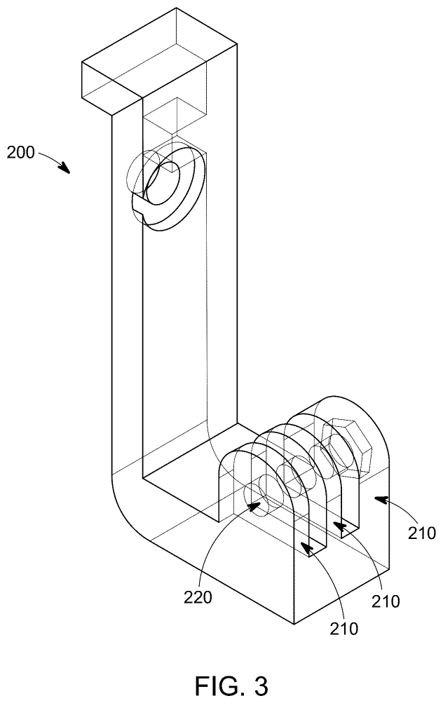

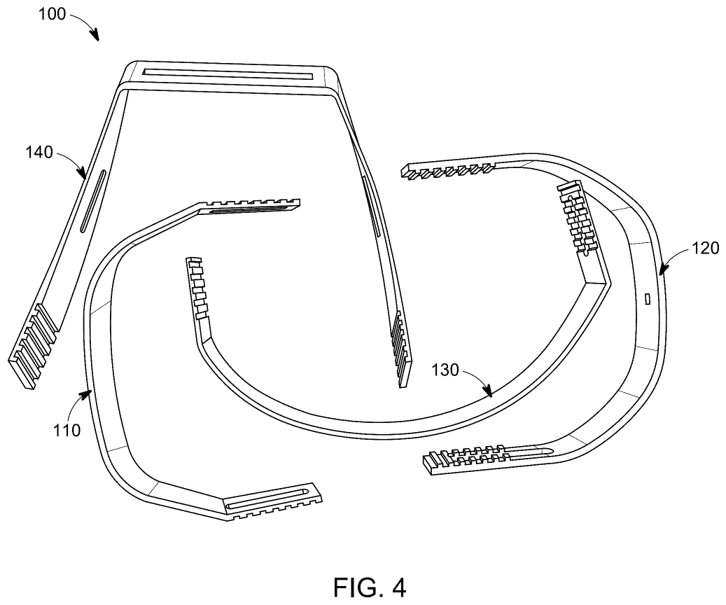

Referring now to the drawings FIGS. 1-5, the head frame for cameras 100 includes a forehead portion 110; a back head portion 120; a top head portion 130; a chin portion 140 all interconnected and adjustable to fit a user's head snugly; and a camera mount 200 that is releasably and adjustably connected to the chin portion 140 and is adapted to releasably hold a camera 300 thereto, such that a user can use the camera 300 in a hands-free mode.

Forehead portion 110 and back head portion 120 can be adjustably interconnected via slot 124 and bolt 126 connections, wherein the bolt can be adjustably tightened via an adjustable wing nut 128. Top head portion 130 can also be adjustably interconnected to the forehead portion 110 and back head portion 120 via slot 124 and bolt 126 connections. And chin portion 140 can also be adjustably interconnected to the forehead portion 110 and back head portion 120 via the same slot 124 and bolt 126 connections that are used to interconnect them to each other.

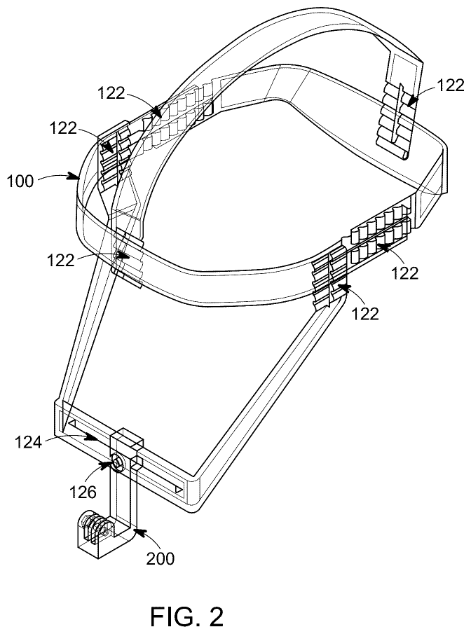

As shown in FIG. 2, the camera mount 200 is adjustably interconnected to the chin portion 140 via a slot 124 and bolt 126 connection, wherein the slot 124 is in the chin portion 140 and the bolt 126 is extending from the camera mount 200. The slot 124 may also be formed having a rectangular shape, and the camera mount 200 may also include a rectangular protrusion formed to fit and slide within the rectangular slot to reduce unwanted pivotal movement therebetween. Furthermore, each of the slot and bolt connections may further include interdigitating ridges 122 upon each respective portion adapted to more securely hold each portion to each other in precise chosen positions.

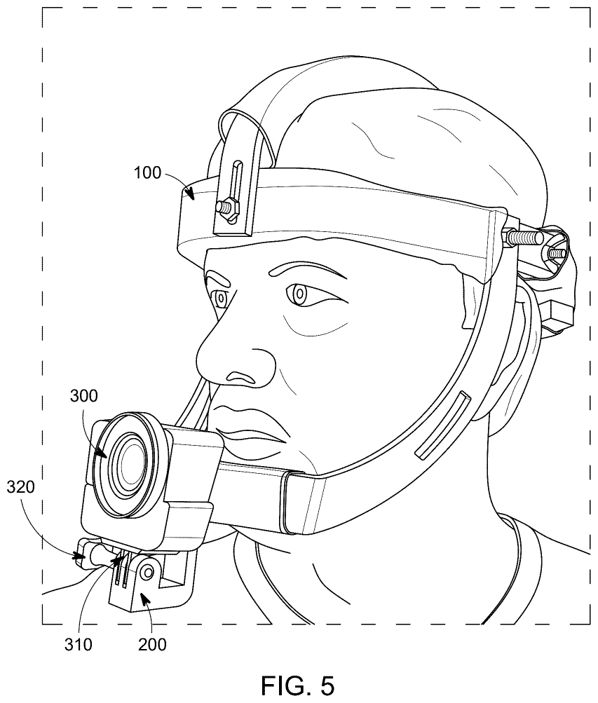

As shown in FIG. 5, camera 300 is adjustably interconnected to camera mount 200, wherein camera mount 200 further includes three connector panels 210 having holes 220 therethrough adapted to interdigitate and pivotally connect with a two panel bracket 310, also having holes therethrough, of camera 300 using a camera bracket fastener 320, preferably formed as a nut and bolt arrangement, though it can also be formed as a friction bolt, cam lever, or other similar types of fasteners. As such, camera 300 can be frictionally and releasably held at a chosen angle to the camera mount 200 in a hands-free mode.

Also as shown in FIG. 5, portions of the head frame for cameras 100 can be covered with padding for the comfort of the wearer. The padding can consist of cotton or nylon fabric or any similar material, or as a cotton or nylon fabric outer cover filled a material such as cotton or nylon fibers or any similar material.

The different parts of the head frame for cameras 100 can be formed from a variety of materials including plastic, aluminum, steel, copper, and fiberglass.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

What is claimed is:

1. A head frame for cameras comprising:
a forehead portion;
a back head portion;
wherein said back head portion is adjustably connected to said forehead portion;
a top head portion;
wherein said top head portion is adjustably connected between said forehead portion and said back head portion; and
a chin portion;
wherein said chin portion is adjustably connected to said forehead portion and said back head portion; and
wherein said forehead portion, said back head portion, said top head portion, and said chin portion are adapted and adjustably interconnected to form a shape that fits a user's head snugly; and
a camera mount;
wherein said camera mount is adjustably connected to said chin portion and is adapted to adjustably and releasably hold a camera thereto, such that when said head frame for cameras is in use a user can use said camera in a hands-free mode.

2. The head frame for cameras of claim 1, wherein said forehead portion and said back head portion each include at least one slot therein that are adapted to be placed adjacent to each other at a chosen position; and wherein said head frame for cameras further comprises at least one nut and bolt fastener adapted to be placed through said adjacent slots and is adapted to frictionally and releasably hold said forehead portion and said back head portion in said chosen position.

3. The head frame for cameras of claim 2, wherein said forehead portion and said back head portion further include a respective series of ridges thereon adapted to interdigitate with one another at said chosen position and more securely hold said forehead portion and said back head portion in said chosen position.

4. The head frame for cameras of claim 1, wherein said chin portion includes at least one slot therein adapted to be placed adjacent said slots of said forehead portion and said back head portion; and wherein said head frame for cameras further comprises at least one nut and bolt fastener placed through said adjacent slots of said chin portion, said forehead portion, and said back head portion and is adapted to frictionally and releasably hold said chin portion in a chosen position with respect to said forehead portion and said back head portion.

5. The head frame for cameras of claim 4, wherein said chin portion, said forehead portion, and said back head portion further include a respective series of ridges thereon adapted to interdigitate with one another at said chosen position and more securely hold said chin portion in said chosen position with respect to said forehead portion and said back head portion.

6. The head frame for cameras of claim 1, wherein said top head portion is adjustably connected between said forehead portion and said back head portion; wherein said top head portion includes slots on first and second ends thereof; wherein said head frame for cameras further comprises a nut and bolt fastener placed through said forehead portion and said slot on said first end of said top head portion to frictionally and releasably hold said first end of said top head portion in a chosen position with respect to said forehead portion; and wherein said head frame for cameras further comprises a nut and bolt fastener placed through said back head portion and said slot on said second end of said top head portion to frictionally and releasably hold said second end of said top head portion in a chosen position with respect to said back head portion.

7. The head frame for cameras of claim 6, wherein said first and second ends of said top head portion, said forehead portion, and said back head portion further include a respective series of ridges thereon adapted to interdigitate with one another at said chosen positions and more securely hold said top head portion in said chosen position with respect to said forehead portion and said back head portion.

8. The head frame for cameras of claim 1, wherein said chin portion includes at slot therein; and wherein said head frame for cameras further comprises a nut and bolt fastener adapted to be placed through said camera mount and said slot of said chin portion and frictionally and releasably hold said camera mount to said chin portion in a chosen position.

9. The head frame for cameras of claim 1, wherein said camera mount includes a plurality of spaced connector panels having holes therethrough aligned with one another and are adapted to interdigitate and pivotally connect with a panel bracket of a camera also having holes aligned therethrough, such that a camera bracket bolt can be used to frictionally and releasably hold said camera mount at a chosen angle to said panel bracket of said camera.

10. A combination of a camera and a head frame for cameras, comprising:
a camera including:
a panel bracket including:
at least two spaced panels having holes therethrough aligned with one another; and
a camera bracket fastener;
wherein said camera bracket fastener is adapted to pass through said holes of said two spaced panels of said panel bracket and through aligned holes within spaced panels of a camera mount, such that said panel bracket can be releasably held at a chosen angle to said camera mount; and
a head frame for cameras comprising:
a forehead portion;
a back head portion;
wherein said back head portion is adjustably connected to said forehead portion;
a top head portion;
wherein said top head portion is adjustably connected between said forehead portion and said back head portion; and
a chin portion;
wherein said chin portion is adjustably connected to said forehead portion and said back head portion; and
wherein said forehead portion, said back head portion, said top head portion, and said chin portion are adapted and adjustably interconnected to form a shape that fits a user's head snugly; and
a camera mount including:
a plurality of spaced connector panels having holes therethrough aligned with one another and are adapted to align with said holes of said at least two spaced panels of said panel bracket of said camera and interdigitate and pivotally connect with said panel bracket, such that said camera bracket fastener can be used to frictionally and releasably hold said camera mount at a chosen angle to said panel bracket of said camera; and
wherein said camera mount is adjustably connected to said chin portion and is adapted to adjustably and releasably hold said camera thereto, such that when said head frame for cameras is in use a user can use said camera in a hands-free mode.

11. The combination of claim 10, wherein said forehead portion and said back head portion each include at least one slot therein that are adapted to be placed adjacent to each other at a chosen position; and wherein said head frame for cameras further comprises at least one nut and bolt fastener adapted to be placed through said adjacent slots and is adapted to frictionally and releasably hold said forehead portion and said back head portion in said chosen position.

12. The combination of claim 11, wherein said forehead portion and said back head portion further include a respective series of ridges thereon adapted to interdigitate with one another at said chosen position and more securely hold said forehead portion and said back head portion in said chosen position.

13. The combination of claim 10, wherein said chin portion includes at least one slot therein adapted to be placed adjacent said slots of said forehead portion and said back head portion;
and wherein said head frame for cameras further comprises at least one nut and bolt fastener placed through said adjacent slots of said chin portion, said forehead portion, and said back head portion and is adapted to frictionally and releasably hold said chin portion in a chosen position with respect to said forehead portion and said back head portion.

14. The combination of claim 13, wherein said chin portion, said forehead portion, and said back head portion further include a respective series of ridges thereon adapted to interdigitate with one another at said chosen position and more securely hold said chin portion in said chosen position with respect to said forehead portion and said back head portion.

15. The combination of claim 10, wherein said top head portion is adjustably connected between said forehead portion and said back head portion; wherein said top head portion includes slots on first and second ends thereof; wherein said head frame for cameras further comprises a nut and bolt fastener placed through said forehead portion and said slot on said first end of said top head portion to frictionally and releasably hold said first end of said top head portion in a chosen position with respect to said forehead portion; and wherein said head frame for cameras further comprises a nut and bolt fastener placed through said back head portion and said slot on said second end of said top head portion to frictionally and releasably hold said second end of said top head portion in a chosen position with respect to said back head portion.

16. The combination of claim 15, wherein said first and second ends of said top head portion, said forehead portion, and said back head portion further include a respective series of ridges thereon adapted to interdigitate with one another at said chosen positions and more securely hold said top head portion in said chosen position with respect to said forehead portion and said back head portion.

17. The head frame for cameras of claim 10, wherein said chin portion includes at slot therein;
and wherein said head frame for cameras further comprises a nut and bolt fastener adapted to be placed through said camera mount and said slot of said chin portion and frictionally and releasably hold said camera mount to said chin portion in a chosen position.
